(19) United States
(12) Patent Application Publication
(10) Pub. No.: US 2006/0075905 A1
(43) Pub. Date: Apr. 13, 2006

(54) EASY ROASTING AND SIMMERING DEVICE

(76) Inventor: Shi-Kun Shih, Taipei City (TW)

Correspondence Address: BACON & THOMAS, PLLC, 625 SLATERS LANE, FOURTH FLOOR, ALEXANDRIA, VA, 22314, US

(21) Appl. No.: 10/959,089

(22) Filed: Oct. 7, 2004

(51) Int. Cl. A47J 37/04

(52) U.S. Cl. 99/419

(57) ABSTRACT

An easy roasting and simmering device comprising a case, a cover and a roasting shelf, the case and the cover are made from cardboards, a net can be provided in the case, the cover can be closed, the case and the cover are provided respectively with an air inlet and an air ventilation hole to make convection of air in the case; the roasting shelf is composed of a plurality of plates provided at the bottom of the case, thereby effects of easy assembling and roasting and simmering food can be obtained.

### BACKGROUND OF THE INVENTION

1. Field of the Invention

The present invention is related to an easy roasting and simmering device, and especially to an easy roasting and simmering device that can be assembled in a simple, easy and fast way, and can afford effective food roasting and simmering.

2. Description of the Prior Art

Food, clothing, domiciles and means for moving are necessary for human life, wherein eating food is one of the instincts of all animals. Since appearing of human, food has been essential for them; otherwise, men will have no energy, and thereby food controls people's life.

A way of cooking food is simmering which uses the so-called “earthen oven”, in the present day, we use an aluminum barrel loaded therein with food such as chicken meat; the interior of the aluminum barrel is made sealed, it is heated for simmering till the food is cooked.

Operation of simmering with the above stated aluminum barrel is used mostly by venders and can not be popularized for normal families for carrying during traveling or can not be used in households, this is because that the barrel is relatively large, more expensive and is inconvenient for carrying.

Moreover generally, when people travel, utensils for meat roasting are mostly articles for carrying, conventional utensils for meat roasting can only afford operation of meat roasting for users; in the present days, people require fast, convenient operation and environment protection, an utensil for meat roasting must meet the requirement of convenience for assembling and recovering in addition to being used for meat roasting.

Therefore, it is the gist of the present invention to find how to provide a roasting and simmering device that is convenient for assembling and recovering.

### SUMMARY OF THE INVENTION

In view of the above statement, for the purpose of providing a roasting and simmering device that is convenient for assembling and recovering, the inventor of the present invention develops an easy roasting and simmering device based on his professional experience of years in studying, designing and manufacturing same kind of products and after hard study, developing, as well as repeated experiments and tests.

The easy roasting and simmering device of the present invention comprises a case, a cover and a roasting shelf; the case and the cover are made from cardboards; a net can be provided in the case, the cover can be closed; the case and the cover are provided respectively with an air inlet and an air ventilation hole to make convection of air in the case; the roasting shelf is composed of a plurality of plates provided at the bottom of the case, thereby effects of easy assembling, roasting and simmering food can be obtained.

The primary object of the present invention is: by cooperation of the case and the cover with the roasting shelf, air in the case can form convection in the case; this can not only keep burning of charcoal, but also do simmering on food placed in the case.

The secondary object of the present invention is: the roasting shelf is composed of a plurality of plates; they can not only be utilized in cooperation with the case to do simmering, but also to solely roast with the roasting net.

The present invention will be apparent in its content and effects after reading the detailed description of the preferred embodiment thereof in reference to the accompanying drawings.

### BRIEF DESCRIPTION OF THE DRAWINGS

FIG. 1 is a perspective schematic view showing manufacturing of a forked pipe article from extruded material in the present invention;

FIG. 2 is a sectional schematic view of the present invention;

FIG. 3 is a sectional schematic view showing air convection in the case of the present invention;

FIG. 4 is a perspective schematic view of a roasting shelf of the present invention;

FIG. 5 is a perspective view of a first example of the roasting shelf of the present invention;

FIG. 6 is a perspective view of a second example of the roasting shelf of the present invention;

FIG. 7 is a perspective schematic view showing spreading out of the elements of the present invention in storing;

FIG. 8 is a sectional schematic view showing use of a second embodiment of the present invention.

### DETAILED DESCRIPTION OF THE PREFERRED EMBODIMENT

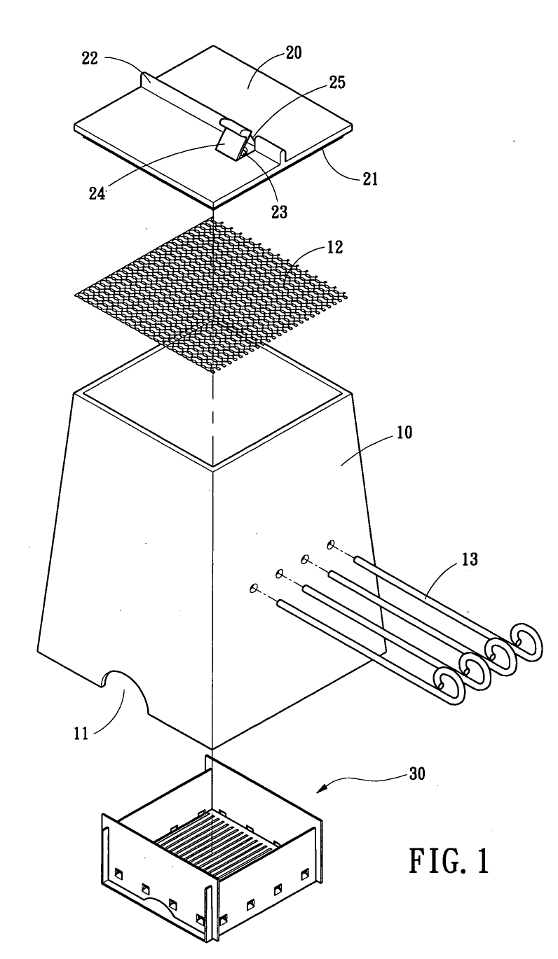

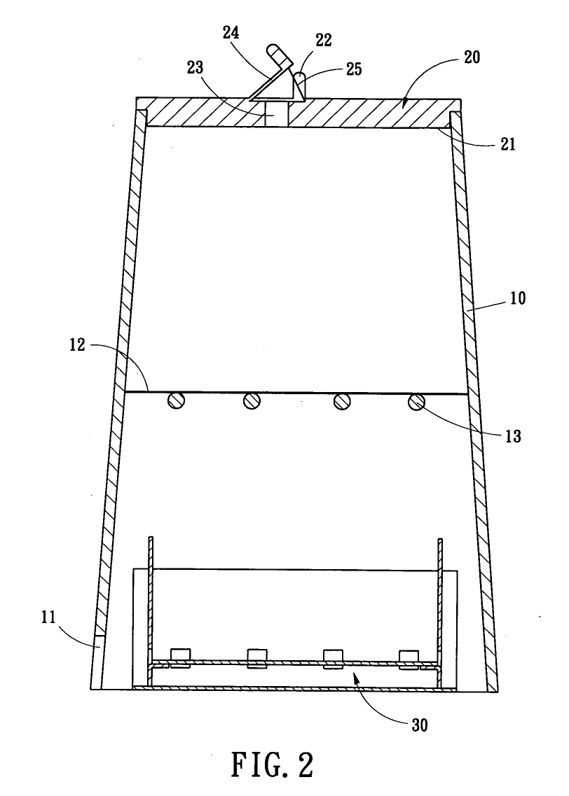

Referring firstly to FIGS. 1-3, the easy roasting and simmering device of the present invention comprises in its structure a case 10, a cover 20 and a roasting shelf 30.

Wherein: the case 10 is a cubic member formed from a plurality of cardboards having an opened upper side and an opened lower side (in the present invention, the case 10 is a truncated rectangular pyramid, a polygonal, a cylindrical or a rectangular cubic member); the case 10 has on a bottom edge of a lateral side thereof an air inlet 11, a net 12 can be provided in the case 10; the present invention uses a plurality of rods 13 extending through the case 10, so that the net 12 can be placed on the rods 13 (this is for an embodiment of the present invention, alternatively, the present invention can be directly integrally formed in the case a protruding plate for placing the net, but the plate is not shown).

The cover 20 is closed on the case 10, and forms on one side thereof facing to the opening of the case 10 a protruding plate 21, the cover 20 has thereon a handle 22 and a ventilation hole 23 to make convection of air with the air inlet 11 in the case 10; a lid 24 is provided on the ventilation hole 23, and a top plate 25 is provided between the lid 24 and the ventilation hole 23, so that the top plate 25 can hold the lid 24 when in an opened stated.

The roasting shelf 30 is provided at the bottom in the case 10, it can allow placing charcoals 40 thereon.

Thereby when the charcoals 40 are piled up on the roasting shelf 30, the charcoals 40 burn in the case 10; by providing the air inlet 11 on a lateral side of the case 10, and by providing the ventilation hole 23 on the cover 20, air in the case 10 can create convection to keep continuous burning of the charcoals 40, the net 12 in the case 10 can be loaded thereon with food 50 for simmering; by the high temperature generated during burning of the charcoals 40, and the convection of air, the food 50 can absorb the ambient hot air to get the object of simmering.

In view that in simmering generally, the temperature for simmering for the food 50 is supposed not to be too high; when it is too high, the food 50 will be charred; while when it is too low, the time for simmering will be prolonged; thereby normally the temperature is kept between about 200 to 215° C. However, the heat resisting temperature of the case 10 of the present invention is about 250° C., and the temperature becomes higher according to the material used for the case 10; hence during the process of simmering, the case 10 can be assured not to burn, it is safe without a need of worrying.

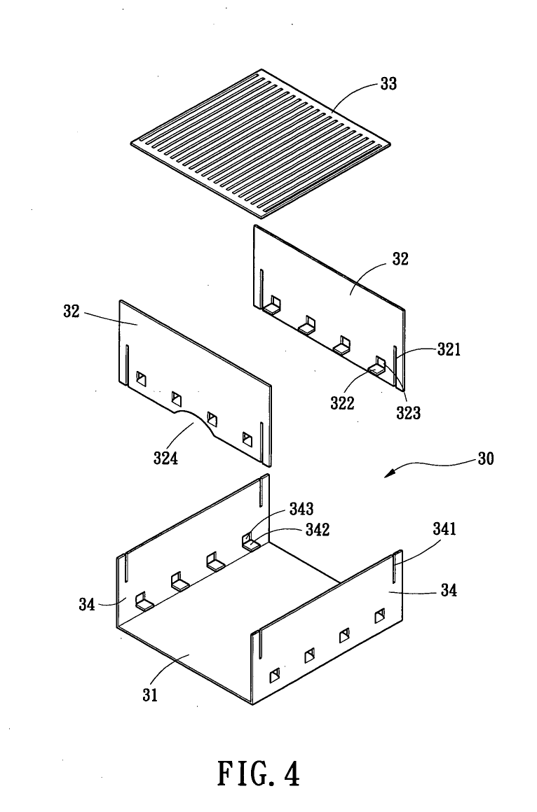

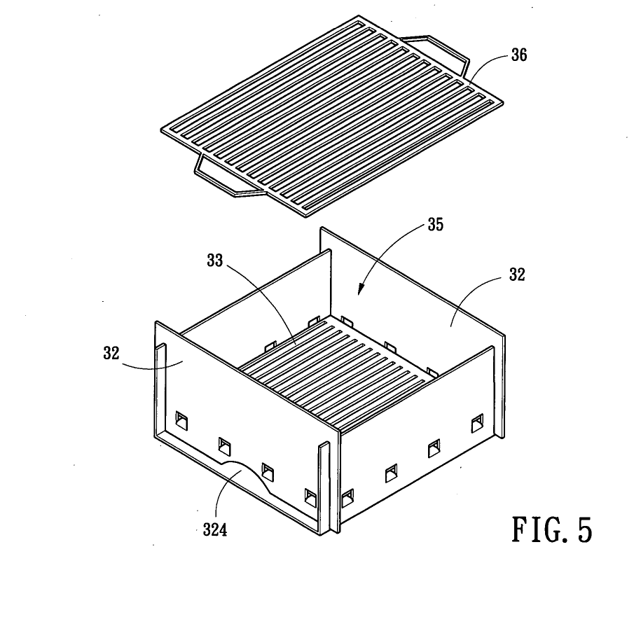

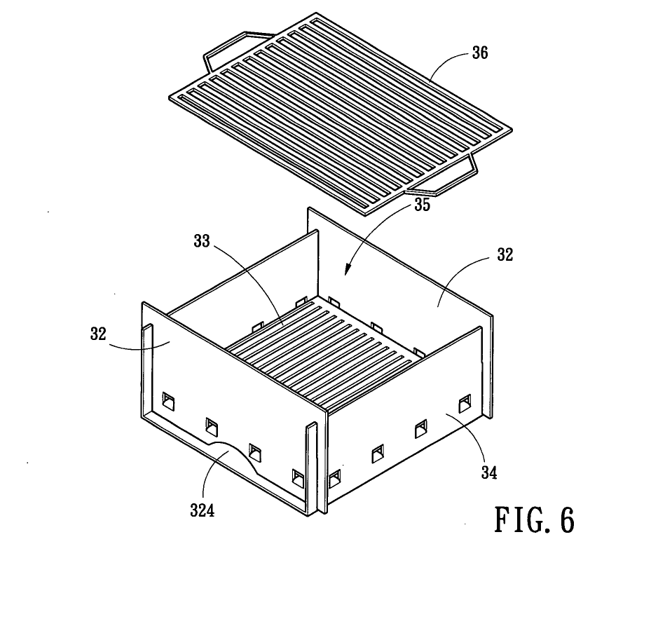

Referring to FIGS. 4-6, the roasting shelf 30 is composed of a base plate 31, two upright sheets 32 and a horizontal shelf plate 33; the base plate 31, the upright sheets 32 and the horizontal shelf plate 33 are made of aluminum or metallic material, the base plate 31 is provided on its two lateral sides with bendable folded plates 34 respectively, the folded plates 34 and the upright sheets 32 are provided with cuts 341, 321 respectively, so that the upright sheets 32 can be insertion connected onto the folded plates 34 through these cuts 341, 321, and form a receiving space 35 together with the base plate 31.

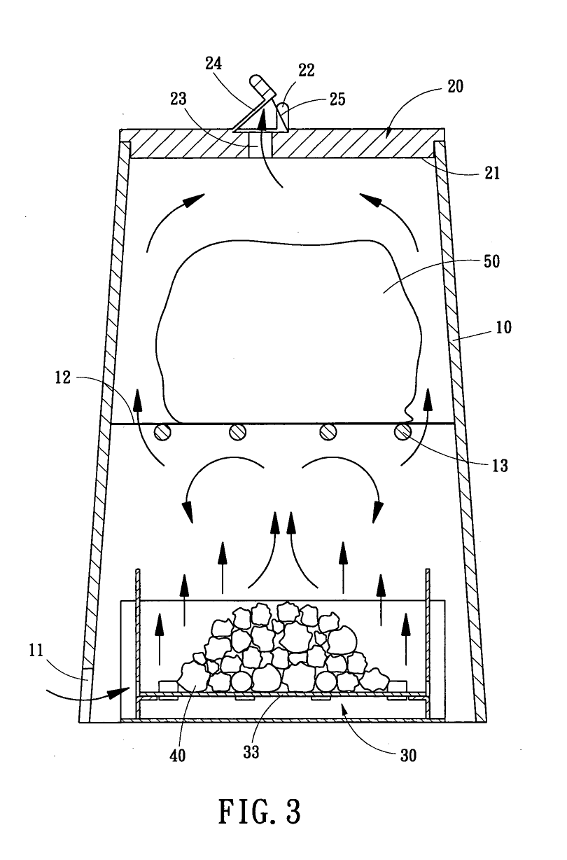

The folded plates 34 and the upright sheets 32 are respectively provided with pressing plates 342, 322 which are folded by pressing toward the inside of the receiving space 35, and are formed respectively thereon with air holes 343, 323; the pressing plates 342, 322 are allowed to place thereon the shelf plate 33 which is used mainly for placing thereon the charcoals 40, referring also to FIG. 3, air can flow into the receiving space 35 through the air holes 343, 323.

Further, one of the upright sheets 32 can be provided thereon with an arced notch 324, so that when the upright sheets 32 are assembled with the base plate 31, air can enter the bottom area of the shelf plate 33 through the arced notch 324 and form air convection with the air holes 343, 323 in favor of burning of the charcoals 40.

The roasting shelf 30 can be used singularly in addition to being able to cooperate with the case 10 in application; by virtue that when in assembling the upright sheets 32 with the base plate 31, the heights of the upright sheets 32 are slightly larger than that of the folded plates 34, thereby a roasting net 36 can be placed on the upright sheets 32 or the folded plates 34 in pursuance of the option of a user according to different situations, and thus the roasting shelf 30 can get its effect of meat roasting.

Because the upright sheets 32 and the folded plates 34 have a suitable height difference between them, hence when in selecting food that is easy to be done by roasting, the roasting net 36 can be placed on the folded plates 34 to make the food more close to the charcoals 40, and to speed up the effect of roasting. On the contrary, when in selecting food that is uneasy to be done by roasting, the roasting net 36 can be placed on the upright sheets 32 to make the food more distant from the charcoals 40, then temperature of the charcoals 40 will not be overly high to render the food to have a state of being done externally but still raw internally.

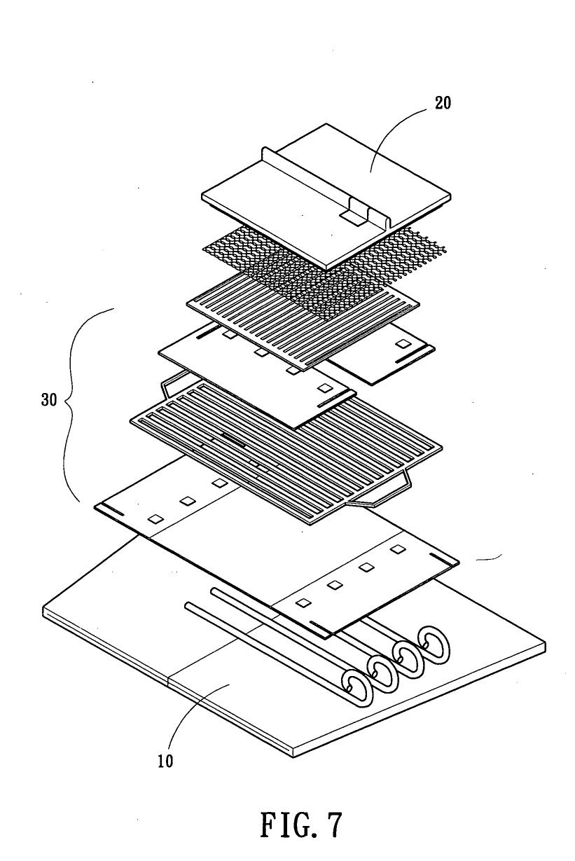

Referring to FIG. 7, The easy roasting and simmering device of the present invention has another feature in addition to the effect of roasting and simmering: the case 10, the cover 20 and the roasting shelf 30 can be completely spread out for mutually lapping, so that they can be stored in a box for the convenience of carrying; the elements stored occupy small volumes and are convenient for storing; moreover, the case 10, the cover 20 and the roasting shelf 30 are made from cardboards or of aluminum or metallic material, they cost low by production, and can get an object of recovering resources.

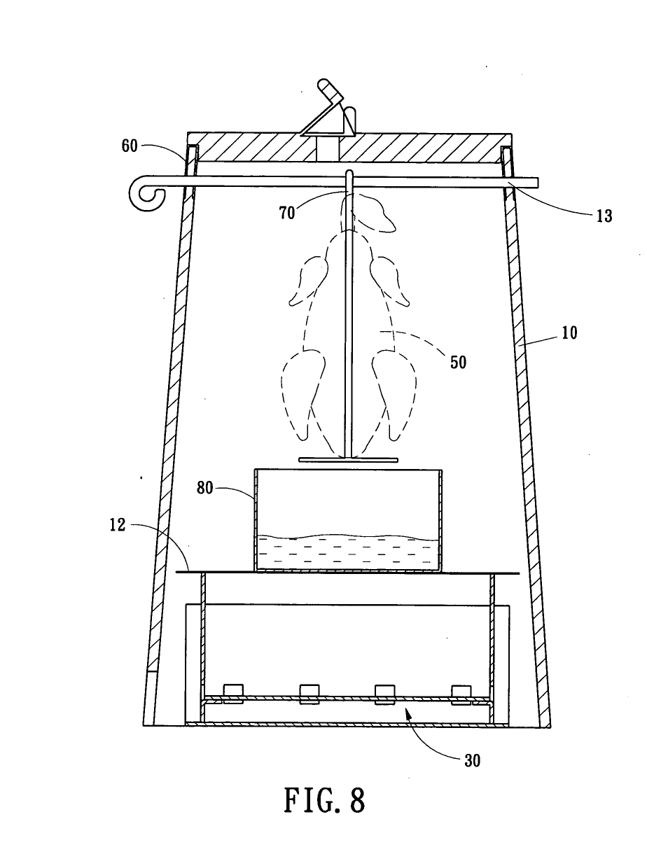

And more, referring to FIG. 8, the case 10 is provided on its top opening with mutually opposite iron sheets 60 which are provided with holes, so that every one of the rods 13 can be extended through two holes of the iron sheets 60 for hanging a rod hanger 70, the rod hangers 70 are used to hang food 50 in strings; and the net 12 is provided on the roasting shelf 30 in order that a pot 80 can be placed on the net 12 and right below the rod hangers 70. Thereby, during simmering the food 50, extract generated by the food 50 can drip into the pot 80. During simmering a chicken, we can render the extract to drip into the pot 80 to form chicken soup; thereby an effect of cooking chicken soup during simmering can be obtained.

One thing is worth mentioning, referring to all the drawings, when the case 10 is not yet loaded with food, the lid of the cover 20 can be closed to prevent convection of the air in the case 10; thereby the speed of burning of the charcoals 40 can be retarded to increase the life of use of the charcoals 40; while the case 10 is further provided on its inner wall with aluminum foils, by heat conduction of the aluminum foils, the effect of simmering in the case 10 is increased.

The easy roasting and simmering device of the present invention can get its effect of solely roasting using the roasting shelf 30 in addition to doing simmering in the case 10 and the cover 20 in cooperating with the roasting shelf 30; it has a double usage.

The rods 13 can further cooperate with the roasting shelf 30 for roasting strings of meat, so that a user can string slices of meat on the rods 13 for roasting.

The names of the members composing the present invention are only for illustrating the present invention, and not for giving any limitation to the scope of the present invention; it will be apparent to those skilled in this art that various modifications or changes without departing from the spirit of this invention shall also fall within the scope of the appended claims.

1. An easy roasting and simmering device comprising:
a case being a cubic member formed from a plurality of cardboards having an opened upper side and an opened lower side; said case has on a bottom edge of a lateral side thereof an air inlet, a plurality of rods are extended through said case, and a net is provided in said case;
a cover formed from a plurality of cardboards, being closed on said case, said cover has thereon a handle for holding and a ventilation hole to make convection of air with said air inlet;
a roasting shelf provided at the bottom in said case, said roasting shelf allows placing charcoals thereon; and
wherein said roasting shelf is composed of a base plate, two upright sheets and a horizontal shelf plate; said base plate is provided on its two lateral sides with bendable folded plates respectively, said folded plates and said upright sheets are provided with cuts respectively, so that said upright sheets are insertion connected onto said folded plates through said cuts and form a receiving space together with said base plate; said folded plates and said upright sheets are respectively provided with pressing plates which are folded by pressing toward the inside of said receiving space, and are formed respectively thereon with air holes; said pressing plates are allowed to place thereon said horizontal shelf plate.

2. The easy roasting and simmering device as in claim 1, wherein: said case is integrally formed therein a protruding plate for placing said net.

3. (canceled)

4. The easy roasting and simmering device as in claim 1, wherein: a lid is provided on said ventilation hole, and a top plate is provided between said lid and said ventilation hole, so that said top plate holds said lid in an opened state for simmering in said case.

5. (canceled)

6. The easy roasting and simmering device as in claim 1, wherein: one of said upright sheets is provided thereon with an arced notch, so that when said upright sheets are assembled with said base plate, said air holes make air convection in favor or burning of said charcoals.

7. The easy roasting and simmering device as in claim 1, wherein: said base plate, said upright sheets and said horizontal shelf plate are made of aluminum or other metallic material.

8. The easy roasting and simmering device as in claim 1, wherein: heights of said upright sheets are slightly larger than that of said folded plates, thereby a roasting net is selected and placed on said upright sheets or said folded plates in pursuance of option of a user according to different situations, and said roasting shelf gets its effect of meat roasting.

9. The easy roasting and simmering device as in claim 1, wherein: said case, said cover and said roasting shelf are adapted for completely spreading out to be stored in a box.

10. The easy roasting and simmering device as in claim 1, wherein: said rods are used to hang meat in strings for roasting.

11. (canceled)

12. An easy roasting and simmering device comprising:
a case being a cubic member formed from a plurality of cardboards having an opened upper side and an opened lower side; said case has on a bottom edge of a lateral side thereof an air inlet, a plurality of rods are extended through said case, and a net is provided in said case;
a cover formed from a plurality of cardboards, being closed on said case, said cover has thereon a handle for holding and a ventilation hole to make convection of air with said air inlet; and
a roasting shelf provided at the bottom in said case, said roasting shelf allows placing charcoals thereon;
wherein: said case is provided on its top opening with two mutually opposite iron sheets which are provided with mutually opposite holes, so that every one of said rods is adapted for extending through a couple of said mutually opposite holes of said iron sheets for hanging a rod hanger, said rod hangers are used to hang food in strings.

13. The easy roasting and simmering device as in claim 12, wherein: said case is integrally formed therein a protruding plate for placing said net.

14. (canceled)

15. The easy roasting and simmering device as in claim 12, wherein: a lid is provided on said ventilation hole, and a top plate is provided between said lid and said ventilation hole, so that said top plate holds said lid in an opened state for simmering in said case.

16. The easy roasting and simmering device as in claim 12, wherein: one of said upright sheets is provided thereon with an arced notch, so that when said upright sheets are assembled with said base plate, said air holes make air convection in favor or burning of said charcoals.

17. The easy roasting and simmering device as in claim 12, wherein: heights of said upright sheets are slightly larger than that of said folded plates, thereby a roasting net is selected and placed on said upright sheets or said folded plates in pursuance of option of a user according to different situations, and said roasting shelf gets its effect of meat roasting.

18. The easy roasting and simmering device as in claim 12, wherein: said case, said cover and said roasting shelf are adapted for completely spreading out to be stored in a box.

19. The easy roasting and simmering device as in claim 12, wherein: said rods are used to hang meat in strings for roasting.
